(19) United States
(12) Patent Application Publication
(10) Pub. No.: US 2004/0104283 A1
(43) Pub. Date: Jun. 3, 2004

(54) Injection valve

(76) Inventors: Wolfgang Stoecklein, Stuttgart (DE); Dietmar Schmieder, Markgroeningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/216,432

(22) Filed: Aug. 12, 2002

(30) Foreign Application Priority Data
Aug. 11, 2001 (DE) 1 01 39 622.8

(51) Int. Cl. F02M 59/00; B05B 1/00

(52) U.S. Cl. 239/533.2; 239/600

(57) ABSTRACT

An injection valve for an internal combustion engine, with a nozzle body in which a nozzle needle is guided axially displaceably. An at least one-piece holder body is provided, in which means for actuating the nozzle needle are disposed. The nozzle body has means, which correspond with a holding tool for holding the nozzle body in a defined position relative to the holder body during an assembly.

### BACKGROUND OF THE INVENTION

1. Field of the Invention

The invention is directed to an improved fuel injection valve for an internal combustion engine of a motor vehicle.

2. Description of the Prior Art

Injection valves known in the industry are used particularly in conjunction with common rail reservoir injection systems for Diesel engines and generally include a nozzle body, in which a nozzle needle is guided axially displaceably. One end of the nozzle body, disposed in a combustion chamber of the engine, is provided with openings by way of which fuel is injected into the combustion chamber when the injection valve is open. These openings, whose number preferably ranges between two and eight, are triggered by means of the nozzle needle, and the openings, in the installed position of the injection valve, are disposed such that a defined injection angle and thus a defined injection direction are assured. It is of particular importance that a spark plug that also protrudes into the combustion chamber not be wetted directly with fuel from the injection valve.

For triggering the nozzle needle, a valvelike actuating device is provided, which is disposed in a so-called holder body. Often, it is provided that the actuating device has a piezoelectric actuator Unit, which serves the purpose of axially displacing a first piston, a so-called adjusting piston. The axial displacement is transmitted to a second piston, a so-called actuating piston, and a hydraulic coupler is disposed between the two pistons. The coupler serves on the one hand to lengthen the adjusting path of the piezoelectric actuator unit and on the other to enable making a longitudinal compensation for length changes resulting from temperature differences.

Via the actuating piston, a valve closing member can be triggered; as a function of a position of the valve closing member, pressure changes in a so-called valve control chamber can be generated. The pressure changes in the valve control chamber cause an axial displacement of the nozzle needle, as a result of which in turn the openings leading to the combustion chamber of the engine are uncovered or closed.

For fixation and calibration of the injection valve in a cylinder head of the engine, the holder body generally has so-called wrench access faces. In the installed state of the injection valve in the cylinder head of the engine, the wrench access faces serve as a marking for orientation or alignment of the injection openings provided on the nozzle body. To enable establishing a defined injection angle during the assembly, it is necessary for the holder body and the nozzle body to have a defined orientation relative to one another. To assure the defined orientation of the holder body and the nozzle body with one another, it has until now been provided that the two components be positioned exactly to one another via centering pins during the assembly.

The nozzle body is firmly screwed to the holder via a nozzle lock nut, which is embodied as a kind of union nut; upon tightening of the nozzle lock nut, the incident frictional forces create a torque, as a result of which the centering pins provided can be deformed or even sheared off. Because of this problem that occurs during assembly of the injection valve, the desired orientation of the nozzle body relative to the holder body is disadvantageously not reliably assured.

Furthermore, the centering pin bores reduce the high-pressure strength of the nozzle body, which can have an especially negative effect in common rail injection valves, in which pressures of up to 1.5 kbar prevail. Also, tolerances in the bores that receive the centering pins lead to imprecise angular centering of the nozzle body and the holder body.

### SUMMARY OF THE INVENTION

The injection valve of the invention in which the nozzle body has means which correspond to a tool for holding the nozzle body in a defined position relative to the holder during an assembly, has the advantage over the prior art that for an angular orientation or angular centering of the nozzle body relative to the holder body, the centering pins used in practice are eliminated, since the nozzle body can be held in a desired or defined position relative to the holder body by means of a holding tool that can be positioned against the nozzle body.

With the elimination of the centering pins between the nozzle body and the holder, or a throttle plate disposed in the holder, the nozzle body has a greater pressure strength, because the bores in an end face of the nozzle body oriented toward the holder are no longer required. Moreover, the production costs for an injection valve are advantageously reduced by the elimination of the expense of centering pins.

In a preferred embodiment of the injection valve of the invention, at least one plane face, disposed on the circumference of the nozzle body, is provided as the means for engagement by a holding tool. Such a face offers a simple capability of engagement by a correspondingly embodied holding tool, with at least one corresponding protrusion engaging the plane face. For instance, the nozzle body can have two plane faces, disposed on opposite sides.

An embodiment with only one plane face, however, offers the advantage that the risk of rotating the nozzle body 1800 relative to the holder body, which would lead to misorientation and make the injection valve unusable, is low.

However, it is also conceivable for the nozzle body to be provided on its circumferential face with at least one groove or blind bore that can be engaged by a suitable holding tool.

The nozzle body and the holder body can be connected to one another via a nozzle lock nut. As a rule, in the region covered by the nozzle lock nut, the nozzle body has an increased wall thickness. In order not to impair the high-pressure strength of the nozzle body, the means for engagement by the holding tool are advantageously embodied in this region, so that they can be at least partly covered by the nozzle lock nut. This assures the pressure-holding capability of the injection valve of the invention, with the means for engagement by the holding tool, which can for instance be embodied as ground faces.

If the means for engagement by a centering tool are embodied as at least one plane face, the nozzle body can be advantageously aligned relative to the holder body in such a way that this face is disposed parallel to the wrench access faces of the holder body. However, any other orientation that enables problem-free centering is also conceivable.

### BRIEF DESCRIPTION OF THE DRAWINGS

Further advantages and advantageous refinements of the subject of the invention will become apparent from the description contained herein below, taken in conjunction with the drawings, in which:

FIG. 1 is a schematic longitudinal section through an injection valve;

FIG. 2 is a schematic longitudinal section through a further embodiment of an injection valve;

FIG. 3 is a detail of the injection valve of FIG. 2, in an enlarged view of the region marked III in FIG. 2;

FIG. 4 is a detail of the injection valve of FIG. 2, in an enlarged view of the region marked IV in FIG. 2;

FIG. 5 is a detail of the injection valve of FIG. 1, in an enlarged view of the region marked V in FIG. 1, together with a holding tool;

FIG. 6 is a simplified cross section through the injection valve of FIGS. 1 and 5 taken along the line VI-VI in FIG. 5;

FIG. 7 is a simplified view of a holding tool in longitudinal section; and

FIG. 8 is a plan view on the holding tool of FIG. 7, in the direction of the arrow VIII in FIG. 7.

### DESCRIPTION OF THE PREFERRED EMBODIMENTS

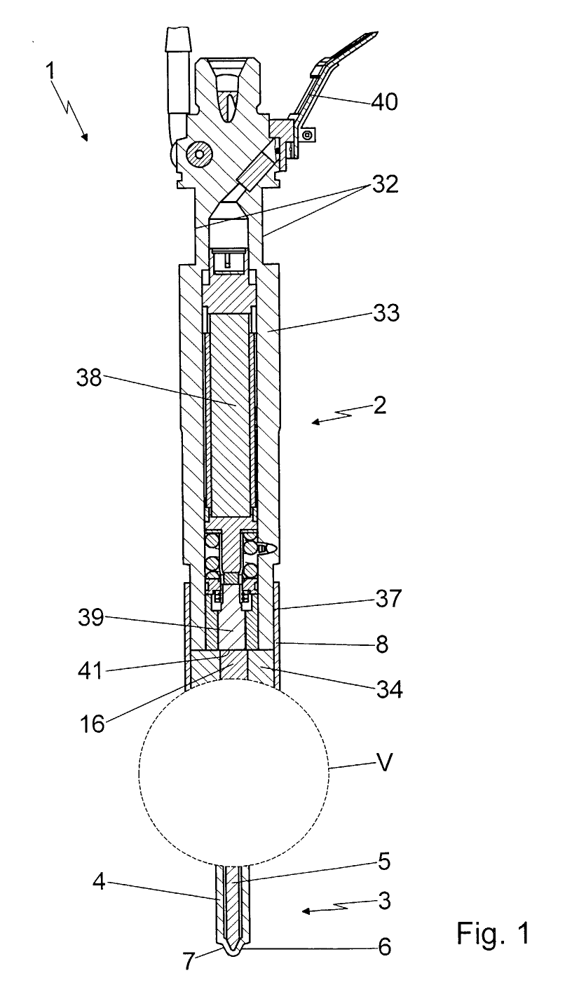

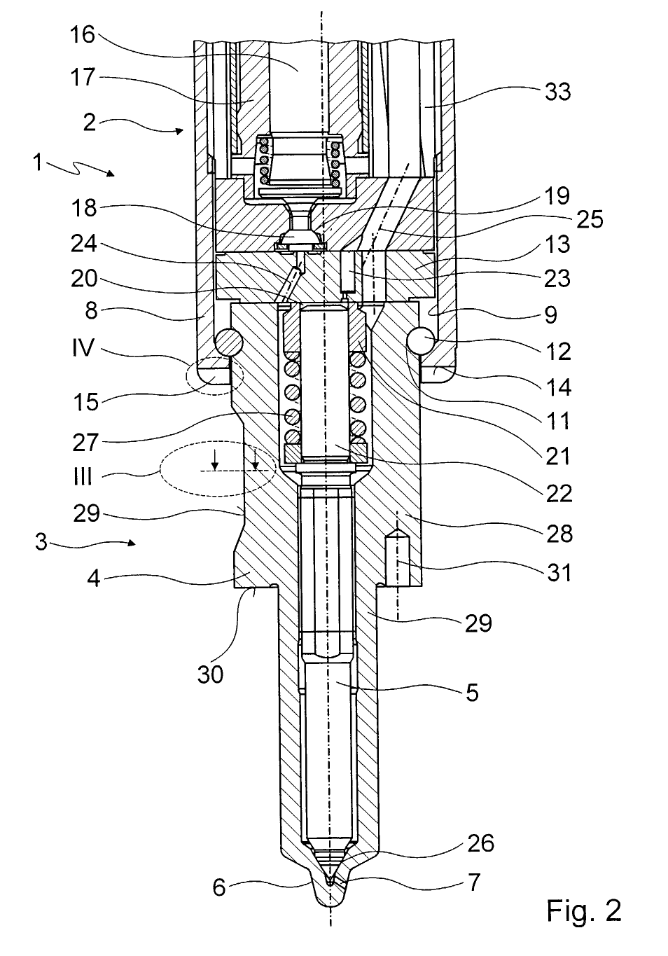

In FIG. 1 and FIG. 2, one injection valve 1 each is shown, by means of which a fuel injection is performed, preferably into a Diesel engine. For the sake of simplicity, the same reference numerals have been chosen for components of identical function in FIGS. 1 and 2.

Each injection valve 1 includes a valve control unit 2 and a nozzle unit 3, with a nozzle body 4 in which a nozzle needle 5 is disposed axially displaceably. A plurality of injection openings 7 are provided on one free end 6 of the nozzle body 4, although only one injection opening 7 is shown in each of the sectional views in FIGS. 1 and 2. Via the injection openings 7, fuel is injected into a combustion chamber, not shown in detail, of the Diesel engine. Depending on the position of the nozzle needle 5, the injection openings 7 are either opened or closed. This means that an injection event is tripped or stopped by way of the axial position of the nozzle needle 5.

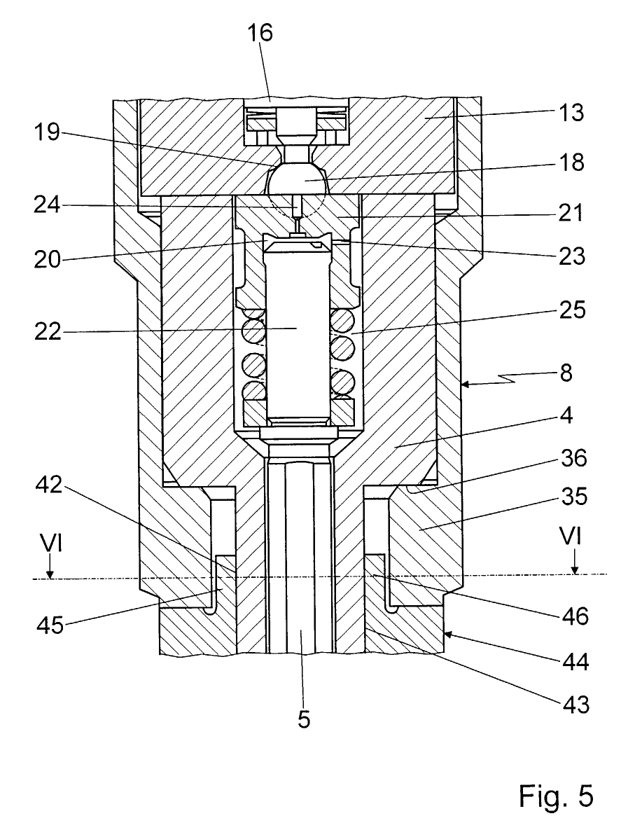

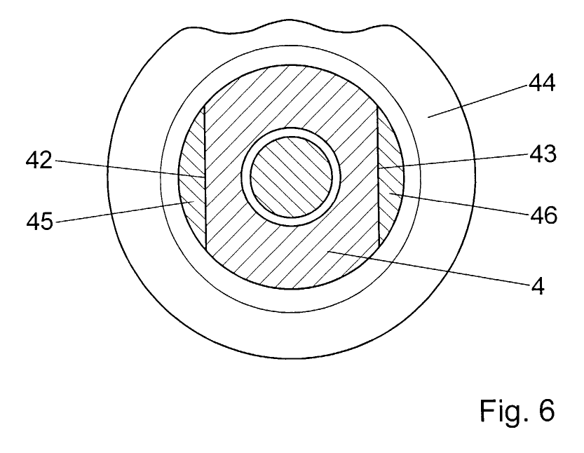

The nozzle needle 5 is actuated via the valve control unit 2 of the injection valve 1; as shown in FIG. 1, the valve control unit 2 has both a holder body 33, provided with so-called wrench access faces 32, and a housing part 34 axially adjoining the holder body 33. The housing part 34, holder body 33 and nozzle body 4, in the embodiment of the injection valve 1 of FIG. 1, are braced together in the axial direction via a nozzle lock nut 8. The nozzle lock nut 8 rests with an annular collar 35, shown in detail in FIG. 5, on a shoulder 36 of the nozzle body 4 and is fixed to the holder body 33 via a thread 37. The shoulder 36 and/or the face of the collar 35 of the nozzle lock nut 8 resting on the shoulder 36 can be coated with a low friction material, such as Teflon, so that when the nozzle lock nut 8 is tightened, only a slight torque is transmitted to the nozzle body.

Both a piezoelectric actuator 30 and a so-called adjusting piston 39, connected to the piezoelectric actuator 38, are disposed in the holder body 33 of the valve control unit 2. The piezoelectric actuator 38 communicates, via electrical lines 40, with a valve controller, not shown here.

The adjusting piston 39 cooperates, via a hydraulic coupler 41, with a so-called actuating piston 16, which is guided in the housing part 34 and cooperates with a valve closing member 18. The valve closing member in turn cooperates with a valve seat 19.

By actuation of the valve closing member 18 by means of the piezoelectric actuator 38, the pressure level can be established in a so-called valve control chamber 20, which is defined on the one hand by a spring plate 21, in which an inlet throttle 23 and an outlet throttle 24 that leads away to the valve control unit 2 are embodied, and on the other hand by a valve control piston 22, which together with the nozzle needle 5 forms a structural unit and which is received axially displaceably in the spring plate 21. An axial offset of the valve control piston 22 and thus of the nozzle needle 5 can be adjusted via a change in the pressure level in the valve control chamber 20.

The inlet throttle 23 connects a high-pressure chamber 25, in which fuel intended for injection into the combustion chamber of the engine is contained, with the valve control chamber 20. An injection event is defined by means of the valve control unit 2, via the openings 7 disposed on the end 5 of the nozzle unit 3.

In the embodiment of the injection valve of FIG. 2, the nozzle lock nut 8 rests with a collar which projects past an inner face 9 of the nozzle lock nut 8, on a snap ring 12 disposed in a groove 11 of the nozzle body 4. Because of this structural design, with increasing screw travel of the nozzle lock nut 8 on the holder body 33, an axial prestressing force is transmitted via the snap ring 12 to the nozzle body 4 and to a throttle plate 13 resting on the nozzle body 4.

To screw the nozzle lock nut 8 together with the holder, a plurality of transverse grooves 15 are provided on the face end 14 toward the nozzle body 4; these transverse grooves can be engaged by an assembly tool, so that the nozzle lock nut 8 can be screwed onto the holder in a simple way. Because of the design of the nozzle lock nut 8 with the transverse grooves 15, a greater accumulation of material of the nozzle lock nut 8 is required only in the region of the transverse grooves 15, so that the nozzle lock nut 8 of the invention can be embodied with a considerably reduced wall thickness than is the case in the injection valves known in practice.

Moreover, the possibility also exists of producing the nozzle lock nut 8 as a deep-drawn part, which makes it possible to reduce the overall production costs of an injection valve.

A pressure level in the valve control chamber 20 is adjustable by an actuation of the valve closing member 18 via the piezoelectric actuator 38, which chamber is defined by the Spring plate 21, the valve control piston 22, and the throttle plate 13. The valve control piston 22 together with the nozzle needle 5 forms a structural unit and is embodied as axially displaceable in the spring plate 21. Here as well, an axial displacement of the valve control piston 22 and thus of the nozzle needle 5 is adjusted via a change in the pressure level in the valve control chamber 20.

An injection onset, injection duration, and injection quantity are defined by means of the valve control unit 2; the injection quantity is dispensed into the combustion chamber via the injection openings 7 disposed on the end 6 of the nozzle unit 3.

The inlet throttle 23 and the outlet throttle 24 are embodied in the throttle plate 13; the inlet throttle 23 connects the high-pressure chamber 25, in which fuel intended for injection into the combustion chamber of the engine is contained, with the valve control chamber 20. If the valve closing member 18 of the injection valve 1 in FIGS. 1 and 2 is actuated by means of the piezoelectric actuator 38, fuel flows out of the valve control chamber 20 via the outlet throttle 24, thus reducing the pressure in the valve control chamber 20 and displacing the valve control piston 22 in the direction of the throttle plate 13. The nozzle needle S in contact with the valve control piston 22 lifts away from a valve seat 26, provided in the interior of the nozzle body 4 in the region of the injection openings 7, so that the injection openings 7 leading to the combustion chamber are uncovered, and fuel is injected into the combustion chamber.

when an actuation of the valve closing member 18 is interrupted by the piezoelectric actuator 38, the valve closing member 18 closes the outlet via the outlet throttle 24, and the pressure in the valve control chamber 20 once again corresponds to the pressure in the high-pressure chamber 25, so that because of the spring force of the spring 27, the nozzle needle 5 again comes to rest on the valve seat 26, and the injection event is terminated.

The nozzle body 4, in a first thickened region 28, has a plane face 29, which forms a so-called means or a holding face that serves as a means or face against which a holding tool can be positioned during an assembly of the injection valve 1.

At a shoulder that forms a transition from the thickened region 28 of the nozzle body 4 to a second, more-slender region 29 of the nozzle body 4, the nozzle body 4 has an end face 30, which is embodied as an annular face. The end face 30 acts as an engagement face for a holding tool during the assembly of the injection valve 1. The nozzle body 4 is positioned in a desired position relative to the holder body, and then the holding tool is placed on the end face 30. Then the entire composite structure of the injection valve 1 is subjected, via the holding tool, to a high axial force; the composite structure is preferably prestressed with an axial force in a range from 40 kN to 60 kN. Next, the nozzle lock nut 8 is screwed onto the holder body 33, until the nozzle lock nut 8 exerts an axial prestressing force on the composite structure that prevents any motion of the nozzle body 4 relative to the holder body.

In order to reduce the high axial prestressing force exerted by the holding tool engaging the end face 30, it is advantageous to make a bore 31 in the end face 30, which bore is engaged by a tang of a holding tool, so that twisting of the nozzle body 4 relative to the holder body 33 during the assembly of the nozzle lock nut 8 is effectively prevented. Thus, twisting of the nozzle body 4 relative to the holder body 33 is prevented not solely via a frictional engagement between the nozzle body 4 and the throttle plate 13; instead, the nozzle body 4 is held either additionally or even solely via a positive engagement between the nozzle body 4 and a holding tool.

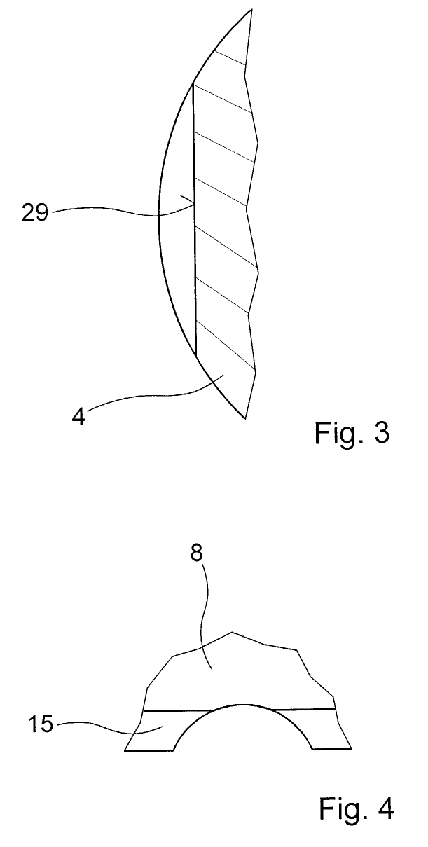

In FIG. 3, the flattened or plane face 29 is shown in detail in the region marked III in FIG. 2, and FIG. 4 shows the transverse grooves 15 in an individual view in the region marked IV in FIG. 2.

As a result of the embodiment of the faces 42 and 43 on the outside of the nozzle body 4 and of the resultant possible engagement by the holding tool 44, it is possible to dispense with centering pins between the nozzle body 4 and the throttle plate 13.

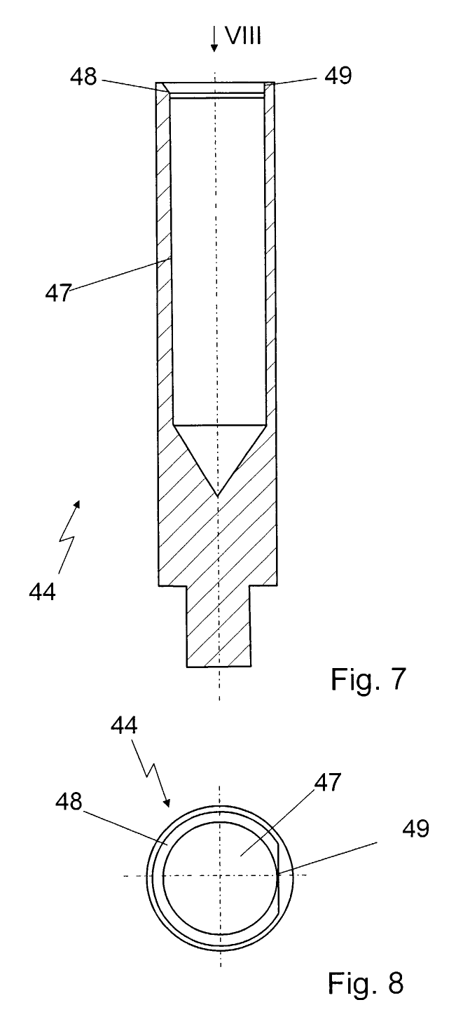

In FIGS. 7 and 8, an alternative embodiment of the holding tool 44 is shown, by means of which tool a nozzle body, not shown in detail here, can be rotated and thus aligned relative to a holder body of an injection valve.

The holding and centering tool 44 is constructed in cup-shaped fashion and has an axially oriented bore 47, so that the holding tool 44 can be slipped onto the nozzle body. In the orifice region, the bore 47 of the holding tool 44 has a conical face 48, embodied on the order of a chamfer, which changes over into an axially oriented level face 49. For centering the nozzle body relative to the holder body, the centering tool 44 is slipped onto the nozzle body, which is preassembled with the holder body via a nozzle lock nut, so that a conical face embodied correspondingly to the nozzle body rests on the conical face 48, and a so-called centering protrusion embodied correspondingly to the nozzle body rests on the flat face 49. In that case, the nozzle body has only one centering lug.

In the next step, the centering tool 44 is rotated in the circumferential direction until such time as the prescribed angular position has been assumed between the nozzle body and the holder body. Next, the nozzle lock nut is tightened, so that the nozzle body and the holder body are connected to one another in a manner fixed against relative rotation; via the centering tool 44 acting as a holding tool in this phase of assembly, a precise position of the holder body relative to the nozzle body is assured.

The foregoing relates to preferred exemplary embodiments of the invention, it being understood that other variants and embodiments thereof are possible within the spirit and scope of the invention, the latter being defined by the appended claims.

We claim:

1. An injection valve (1) for an internal combustion engine, comprising
a nozzle body (4) in which a nozzle needle (5) is guided axially displaceably,
an at least one-piece holder body (33), in which means for actuating the nozzle needle (5) are disposed, and
holding means (29, 30, 31; 42, 43) on the nozzle body (4), the holding means corresponding with a holding tool (44) for holding the nozzle body (4) in a defined position relative to the holder body (33) during an assembly.

2. The injection valve of claim 1 wherein the holding means are embodied as at least an end face (30) of the nozzle body (4).

3. The injection valve of claim 2 wherein the end face (30) is embodied as a sealing face with respect to the cylinder head of the engine.

4. The injection valve of claim 2 wherein the end face (30) is embodied as an annular face of a shoulder of the nozzle body (4).

5. The injection valve of claim 3 wherein the end face (30) is embodied as an annular face of a shoulder of the nozzle body (4).

6. The injection valve of claim 2 further comprising a bore (31) extending in the axial direction of the nozzle body (4) in the region of the end face (30).

7. The injection valve of claim 3 further comprising a bore (31) extending in the axial, direction of the nozzle body (4) in the region of the end face (30).

8. The injection valve of claim 4 further comprising a bore (31) extending in the axial direction of the nozzle body (4) in the region of the end face (30).

9. The injection valve of claim 5 further comprising a bore (31) extending in the axial direction of the nozzle body (4) in the region of the end face (30).

10. The injection valve of claim 1 wherein the holding means comprises as at least one plane face (29; 42, 43) on a circumferential face of the nozzle body (4).

11. The injection valve of claim 1 further comprising a lock nut (8) connecting the nozzle body (4) and the holder body (33) to one another, the lock nut (8) at least partly covering the holding means (42, 43) for engagement by the holding tool (44).

12. The injection valve of claim 11 wherein the nozzle lock nut (8), on its face end (14) toward the nozzle body (4), comprises transverse grooves.

13. The injection valve of claim 10 wherein the holder body (33) has at least two wrench access faces (32), which are oriented essentially parallel to the holding means, the wrench faces being embodied as at least one plane face (42, 43), for engagement by the holding tool (44).

14. The injection valve of claim 11 wherein the nozzle lock nut (8) comprises a collar (10) which protrudes past an inner face (9) and which corresponds with a snap ring (12) disposed in a groove (11) of the nozzle body (4).

15. The injection valve of claim 1 wherein the holder body (33) and the nozzle body (4) each have markings, corresponding with one another, for orientation and alignment of injection openings (7) of the nozzle body (4) in the cylinder head.
